(19) United States
(12) Patent Application Publication
(10) Pub. No.: US 2025/0104045 A1
(43) Pub. Date: Mar. 27, 2025

(54) AUTOMATIC CATEGORIZATION OF TRANSACTIONS

(71) Applicant: Motorola Mobility LLC, Chicago, IL (US)

(72) Inventors: Krishnan Raghavan, Bangalore (IN); Nakul Patel, Bangalore (IN); Vignesh Karthik Mohan, Bangalore (IN)

(73) Assignee: Motorola Mobility LLC, Chicago, IL (US)

(21) Appl. No.: 18/371,195

(22) Filed: Sep. 21, 2023

(51) Int. Cl. G06Q 20/32; G06Q 20/38; G06Q 20/40; G06Q 30/018

(52) U.S. Cl. CPC G06Q 20/3267; G06Q 20/389; G06Q 20/401; G06Q 30/0185

(57) ABSTRACT

In aspects of automatic multi-categorization of transactions, an electronic device detects a transaction event in a transaction application linked to a payment application in an application ecosystem. The electronic device determines that a request for a transfer of digital payment of the transaction event is authorized at the payment application. The electronic device records a total value of the digital payment and a transaction identifier to the transaction event. The electronic device receives, from the transaction application via the data communication network of the application ecosystem, line-item details of the transaction event. The electronic device assigns, from a plurality of categories, a category to each item purchased in the transaction event based on analysis of the line-item details.

### BACKGROUND

Financial technology applications are part of the broader context of online financial services, where financial services are provided over the Internet. Financial technology applications provide the ability for users to access financial data through Internet-connected computing devices such as mobile phones, tablets, laptops, desktop, and automated teller machines (ATMs). The shift from traditional financial services to digital financial technologies has been gradual and remains ongoing, and is constituted by differing degrees of financial service digitization. Financial technology applications offer varying levels of process automation and web-based services. Financial technology applications include application programing interfaces (APIs) that enable cross-institutional services that provide financial products and transactions worldwide, any day of the week, at any time of day.

### BRIEF DESCRIPTION OF THE DRAWINGS

Implementations of the techniques for automatic multi-categorization of transactions are described with reference to the following Figures. The same numbers may be used throughout to reference like features and components shown in the Figures.

FIG. 1 illustrates an example system for automatic multi-categorization of transactions in accordance with one or more implementations as described herein.

FIG. 2 further illustrates an example of automatic multi-categorization of transactions in accordance with one or more implementations as described herein.

FIGS. 3-5 illustrate example methods for automatic multi-categorization of transactions in accordance with one or more implementations of the techniques described herein.

FIG. 6 illustrates various components of an example device that may be used to implement the techniques for automatic multi-categorization of transactions as described herein.

### DETAILED DESCRIPTION

Techniques for automatic multi-categorization of transactions can be implemented to analyze data associated with one or more transactions and provide, based on the analysis, insights into the spending associated with the transactions. The techniques include any combination of hardware, logic, and software to communicate transaction data over a data communication network, to manage transactions across the network, and in addition to providing spend insights, detect potential fraud associated with the transactions. The described techniques can be implemented via any suitable type of device which can include any combination of one or more of mobile devices, wireless devices, smartphones, laptop devices, desktop computers, tablets, wearable computing devices, display devices, or smart TVs.

Implementations of techniques for automatic multi-categorization of transactions may be implemented as described herein and via a variety of different device types, such as a mobile device, a desktop computer, a server device, a collection or servers, and so forth. An electronic device such as any type of a wireless device, mobile device, mobile phone, flip phone, client device, wearable computing device, camera device, companion device, paired device, display device, tablet, computing device, communication device, entertainment device, gaming device, media playback device, and/or any other type of computing and/or electronic device, or a system of any combination of such devices, may be configured to perform techniques for automatic multi-categorization of transactions as described herein. In some cases, at least one mobile device implements an instantiation of a transaction controller, enabling the transaction categorization functionality described herein.

An application ecosystem (e.g., super-app, super app, superapp) may represent a group of applications (e.g., mobile and/or web applications) that are linked to provide multiple services such as shopping, payment services, financial transaction processing, news services, video gaming, media streaming, and the like. With application ecosystems, some data (e.g., login information, purchase history, etc.) is shared across all the associated application. In some cases, an application ecosystem is an application that provides a set of core features while also giving access to independently developed third party applications.

In some conventional approaches, applications may not share some types of information within an application ecosystem. For example, conventional application ecosystems do not share spend insights based on payment transaction details for transaction events (e.g., line-item details of online shopping, shopping via mobile application). Additionally or alternatively, conventional approaches do not implement data communication networks to manage transactions across the network. Spend insights enable users to gain a better understanding of their spending habits by collecting information such as transaction categories, notes, and tags associated with a transaction event. This information is then presented to users across these dimensions.

Further to some conventional approaches, financial institutions may categorize expenses based on the outlet where the transaction is made. For instance, conventional banking systems may detect the category of the expense using different methods such as the category registered by the outlet with a central payment authority. Table 1 illustrates an example of how a conventional bank views the categories of an expense made at different outlets.

In Table 1 the first transaction is made at ABC online store to purchase an electronic item along with a grocery item. Both items are classified as “Department Stores.” The second transaction is made at New City Supermarket to purchase food and grocery items. Again the items are all classified as “Department Stores.” The third transaction is made at 123Charge to purchase an insurance policy, but the purchase is classified as “Utilities” since 123Charge is more commonly used for making bill payments. The last transaction is made at ABC Home Shoppe for a lamp and an electronic device. Both items are classified as “Retail Stores.”

TABLE 1

| | | | |
|---|---|---|---|
| 25 Apr. 2023 | WWW ABC | DEPT STORES | 719.67 Dr |
| | INGURGAONIND | | |
| 28 Apr. 2023 | NEW CITY SUPER | DEPT STORES | 95.00 Dr |
| | MARKET | | |
| | BANGALOREIND | | |
| 30 Apr. 2023 | 123CHARGE | UTILITIES | 504.13 Dr |
| | PAYMENT | | |
| | UTIGURGAONIND | | |
| 1 May 2023 | ABC HOME SHOPPE | RETAIL | 375.00 Dr |
| | BANGALOREIND | STORES | |

These examples of misclassification of expenses are a common problem with conventional financial services. Such misclassifications cause several problems. For example, from the user's standpoint, the categorizations misrepresent purchase information and thus, provide an inaccurate analysis of spending patterns and insights. Users of these conventional approaches to categorization cannot reliably use the financial applications to understand their spend patterns and do financial management based on reliable information. From a financial institution's standpoint, such misclassifications may be used for credit analysis, cross/up-selling, and personalization of services. Such inaccurate information about user's spending habits can result in a poor experience for the end users as conventional financial institutions cannot offer relevant products to the end users. Such misclassifications also result in providing poor quality data to fraud detection and prevention algorithms. Further, such conventional approaches can result in inefficient use of system resources used to attempt to discover correct transaction classifications, such as device resources (e.g., processor bandwidth, memory, etc.) as well as network resources including network bandwidth. Hence accurate expense categorization is important for both users and businesses.

In aspects of the described techniques, a transaction controller implements transaction categorization functionality (e.g., logic, software, and/or hardware) to enable users and financial institutions to harness the advantages of accurate expense categorization. In one or more examples, the transaction categorization functionality is performed via at least one electronic device that implements an instantiation of a transaction controller to analyze transaction data and provide spend insights based on the analysis. The transaction controller implements one or more data communication networks to manage transactions across the network. For example, the transaction controller communicates transaction data over one or more data communication networks and analyzes the transaction data to provide spend insights, detect potential fraud, and enable users to make financial decisions based on spend insights.

In one or more examples, the transaction categorization functionality described herein (e.g., analysis of the line-item details, spend insights, analysis of the spend insights, category assigning, fraud detection, etc.) can be based on a transaction categorization machine learning model. In some cases, the transaction categorization functionality can be based on training the machine learning model to identify a product in a transaction based on training data (e.g., training data that includes a plurality of products). Additionally or alternatively, the transaction categorization functionality can be based on training the machine learning model to identify a category of an identified product based on the training data (e.g., training data that includes a plurality of categories and/or a plurality of product category mappings). Additionally or alternatively, the transaction categorization functionality is based on implementing the transaction categorization machine learning model to communicate transaction data over a data communication network, identify line-item details (e.g., identify product), assign a category of several possible categories to an item purchased in a transaction, identify potential fraud in a transaction, and the like.

The spend insights of the transaction controller can provide users improved financial management. By providing users with detailed information about their spending habits, spend insights help individuals gain a clearer understanding of where their money is going. This enables them to make more informed financial decisions, set budgets, and identify areas where they can potentially save or cut down on expenses. The spend insights of the transaction controller helps users in financial planning and goal tracking. The spend insights of the transaction controller enable users to track their progress towards financial goals. By visualizing their spending habits and comparing them to their savings targets or investment objectives, individuals can adjust their behaviors accordingly and stay on track towards achieving their financial aspirations.

The spend insights of the transaction controller enable financial institutions to provide personalized recommendations. For example, a financial institution can leverage spend insights to offer personalized recommendations and tailored financial advice to their customers. By analyzing spending patterns and identifying trends, financial institutions can suggest suitable financial products or services that align with a customer's needs and goals. The spend insights of the transaction controller enhance fraud detection and prevention. Analyzing transaction data through spend insights enables financial institutions identify suspicious or fraudulent activities. Unusual spending patterns or unauthorized transactions can be detected promptly, allowing financial institutions to take immediate action to protect customer accounts and prevent financial losses.

The spend insights generated by the transaction controller provide multiple advantages. The spend insights of the transaction controller provide targeted marketing and offers. Financial institutions can use spend insights to deliver targeted marketing campaigns and personalized offers to their customers. By accurately understanding their customers' spending preferences and habits, financial institutions can provide relevant promotions, discounts, or rewards that align with their interests, fostering stronger customer engagement and loyalty. The spend insights of the transaction controller enhance credit analysis. By analyzing an individual's spending habits over time, credit analysts are provided a holistic view of their financial stability to evaluate a person's credit worthiness. Identifying changes in spending behavior, such as sudden increases in expenses or reliance on credit for daily necessities, helps assess the potential impact on creditworthiness. Consistent and responsible spending behavior, such as timely payment of bills and managing expenses within means, can indicate good financial discipline and enhance the likelihood of receiving credit approval. Overall, spend insights play a role in empowering individuals to make better financial decisions, detect fraudulent activities in real time (e.g., at the time of payment, before payment, etc.), receive personalized recommendations, and stay in control of their finances.

The transaction controller enables a user to modify and/or add categorizations for transactions. Additionally or alternatively, the transaction controller enables a user to modify and/or add additional attributes such as attaching images, receipts, adding personalized transaction notes, expressing preference towards a transaction, and incorporating customizable tags to represent sub-categories or specific spending purposes.

When a transaction is completed in a shopping service tracked by the transaction controller and paid for by a payment service linked to the shopping service, the transaction controller can identify and proportionately associate the right categories to each item of a transaction even when there are items of different categories. The transaction controller can then show the transaction as proportionately split into multiple categories for correct reporting, even when it's a single transaction.

The described techniques of the transaction controller provide multiple advantages in relation to automatic categorization of data transactions. The described techniques enable users and financial institutions to harness the advantages of accurate expense categorization. The transaction controller implements one or more data communication networks to manage transactions across a network. For example, the transaction controller communicates transaction data over one or more data communication networks and analyzes the transaction data to provide spend insights, detect potential fraud, thwart detected fraud, and enable users to make informed financial decisions based on spend insights. The described techniques improve efficient use of system resources in a timely manner by providing spending insights in real time or within a relatively short period of time after a transaction occurs, providing end users and third-parties with critical information regarding data transactions in a timely and accurate manner.

While features and concepts of the described techniques for automatic multi-categorization of transactions are implemented in any number of different electronic devices, systems, environments, and/or configurations, implementations of the techniques for automatic multi-categorization of transactions are described in the context of the following example devices, systems, and methods.

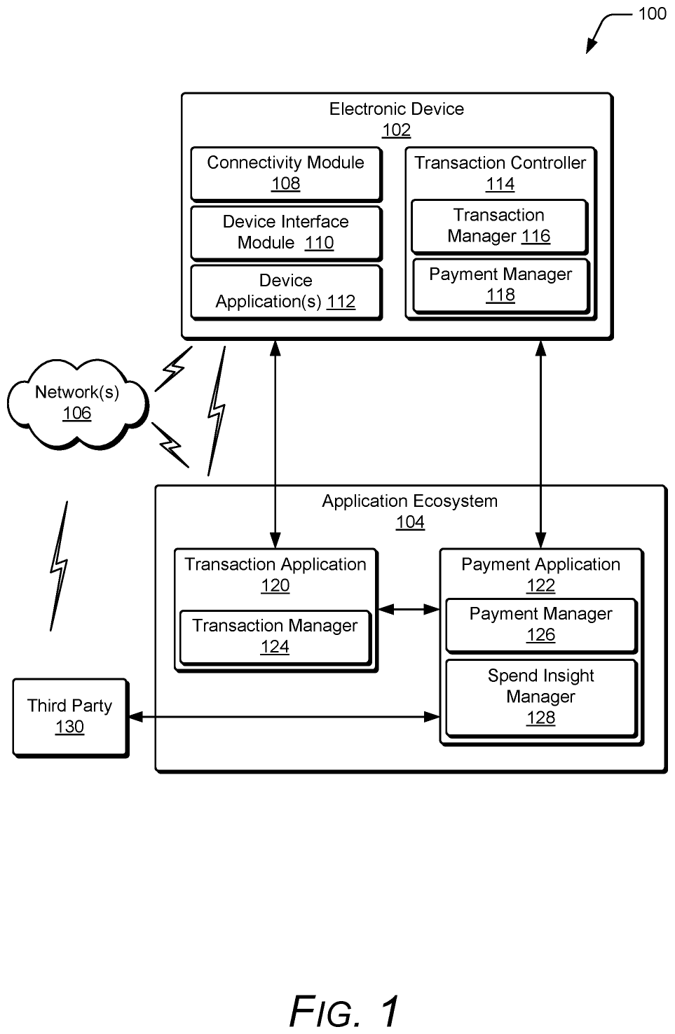

FIG. 1 illustrates an example system 100 for automatic multi-categorization of transactions, as described herein. The system 100 includes an electronic device 102, an application ecosystem 104, and a communication network 106. Examples of electronic devices include at least one of any type of a wireless device, mobile device, mobile phone, flip phone, client device, game controller, wearable computing device, camera device, companion device, paired device, display device, tablet, computing device, communication device, entertainment device, gaming device, media playback device, any other type of computing and/or electronic device, and/or a system of any combination of such devices.

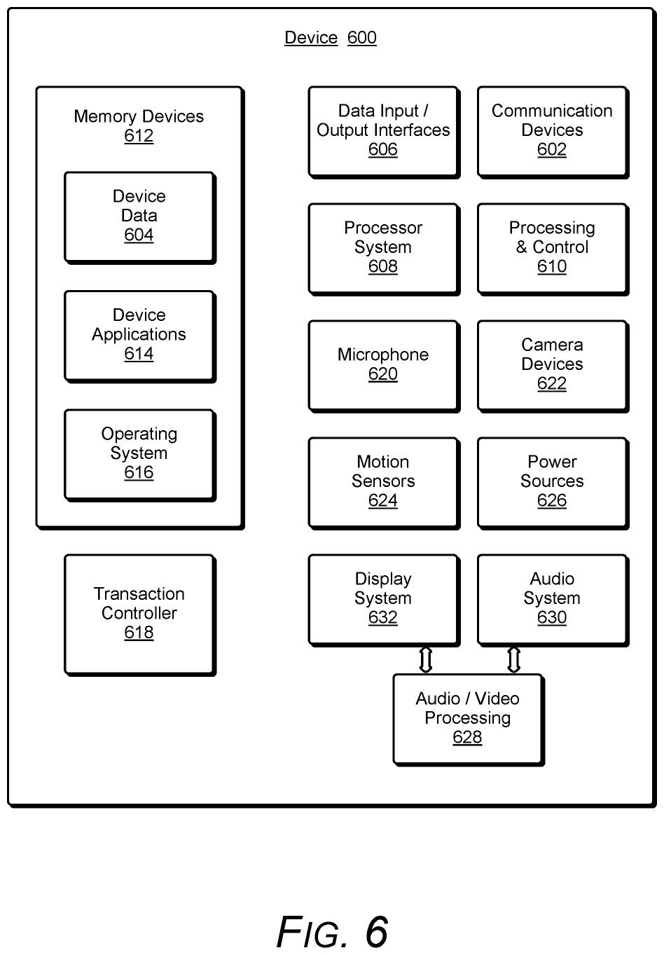

The electronic device 102 and/or the application ecosystem 104 is implemented with various components, such as a processor system and memory, as well as any number and combination of different components as further described with reference to the example device shown in FIG. 6. In implementations, the electronic device 102 includes various radios for wireless communication with other devices. In one or more examples, the electronic device 102 includes at least one of a BLUETOOTH® (BT) or BLUETOOTH® Low Energy (BLE) transceiver, a near field communication (NFC) transceiver, or the like. In some cases, the electronic device 102 includes at least one of a WI-FI® radio, a cellular radio, a global positioning satellite (GPS) radio, or any available type of device communication interface.

The application ecosystem 104 can include any combination of software applications, logic, and hardware such as any type of computer, server device, laptop device, desktop computer, tablet, wireless device, smartphone, mobile device, display device, smart TV, or any other type of computing device. The application ecosystem 104 can be implemented with various components, such as a processor system and memory, as well as any number and combination of the different components as further described with reference to the example device shown in FIG. 6. In implementations, the electronic device 102 is communicatively linked, either by a wired or wireless connection, to the application ecosystem 104. For example, the electronic device 102 and the application ecosystem 104 are communicatively linked via the communication network 106 and/or via direct inter-device connectivity, e.g., via direct wireless and/or wired connectivity between the electronic device 102 and the application ecosystem 104.

In some implementations, the devices, applications, modules, servers, and/or services described herein communicate via the communication network 106, such as for data communication between the electronic device 102 and the application ecosystem 104. The communication network 106 includes a wired and/or a wireless network. The communication network 106 is implemented using any type of network topology and/or communication protocol, and is represented or otherwise implemented as a combination of two or more networks, to include IP-based networks, cellular networks, and/or the Internet. The communication network 106 includes mobile operator networks that are managed by a mobile network operator and/or other network operators, such as a communication service provider, mobile phone provider, and/or Internet service provider.

The electronic device 102 includes various functionalities that enable the device to implement different aspects of automatic multi-categorization of transactions, as described herein. In the illustrated example, the electronic device 102 includes a connectivity module 108, a device interface module 110, device applications 112, and a transaction controller 114. The connectivity module 108 represents functionality (e.g., logic, software, and/or hardware) enabling the electronic device 102 to interconnect with other devices and/or networks, such as the application ecosystem 104 and the communication network 106. For example, the connectivity module 108 enables wireless and/or wired connectivity of the electronic device 102. The device interface module 110 represents functionality enabling the electronic device 102 to interface with other devices. As further detailed below, the device interface module 110 enables the electronic device 102 to establish wireless and/or wired data communication with other devices, such as the application ecosystem 104 and/or other device.

The application ecosystem 104 includes various functionality that enable associated devices to implement different aspects of automatic multi-categorization of transactions, as described herein. In the illustrated example, the application ecosystem 104 includes a transaction application 120 and a payment application 122. In the illustrated example, the transaction application 120 includes a transaction manager 124 and the payment application 122 includes a payment manager 126 and a spend insight manager 128.

In one or more examples, a connectivity session is established between the electronic device 102 and the application ecosystem 104 that enables the electronic device 102 to send transaction data (e.g., line-item details, payment request, etc.) to and/or receive transaction data from the application ecosystem 104. In one or more implementations, the connectivity session is established via intercommunication between the device interface module 110 of the electronic device 102 and the application ecosystem 104 in conjunction with the transaction controller 114. The transaction controller improves management of transactions by providing transaction data in real time or relatively near real time in relation to a data transaction event.

The electronic device 102 and/or the application ecosystem 104 can include and implement device applications 112, such as any type of payment application, shopping application, transaction application, messaging application, email application, media application, data communication application, social platform application, and/or any other of the many possible types of device applications. Many of the device applications 112 have an associated application user interface that is generated and displayed for user interaction and viewing, such as on a display screen of the electronic device 102 and/or on a display of the application ecosystem 104. Generally, an application user interface, or any other type of transaction data, line-item information, spend insight, image, graphic, and the like is digital transaction content that is displayable on the display screen of the electronic device 102 and/or on the display of the application ecosystem 104.

In the example system 100 for automatic multi-categorization of transactions, the electronic device 102 and the application ecosystem 104 can incorporate transaction categorization functionality. At least one of the electronic device 102 or the application ecosystem 104 implements an instantiation of a transaction controller 114 (e.g., as a device application 112). The transaction controller 114 represents functionality (e.g., logic, software, and/or hardware) enabling implementation of described techniques for automatic multi-categorization of transactions. The transaction controller 114 can be implemented as computer instructions stored on computer-readable storage media and can be executed by a processor system of the electronic device 102 and/or of the application ecosystem 104. Alternatively or in addition, the transaction controller 114 can be implemented at least partially in hardware of a device.

In one or more implementations, the transaction controller 114 includes independent processing, memory, and/or logic components functioning as a computing and/or electronic device integrated with the electronic device 102 and/or with the application ecosystem 104. Alternatively or in addition, the transaction controller 114 can be implemented in software, in hardware, or as a combination of software and hardware components. In one or more examples, the transaction controller 114 is implemented as a software application or module, such as executable software instructions (e.g., computer-executable instructions) that are executable with a processor system of the electronic device 102 and/or the application ecosystem 104 to implement the techniques and features described herein. As a software application or module, the transaction controller 114 is stored on computer-readable storage memory (e.g., memory of a device), or in any other suitable memory device or electronic data storage implemented with the module. Alternatively or in addition, the transaction controller 114 is implemented in firmware and/or at least partially in computer hardware. For example, at least part of the transaction controller 114 is executable by a computer processor, and/or at least part of the transaction controller 114 is implemented in logic circuitry.

In the illustrated example, the transaction controller 114 includes a transaction manager 116 and a payment manager 118. In the illustrated example, the transaction controller 114 provides transaction categorization functionality to mobile devices based on the operations of the transaction manager 116 and/or the payment manager 118. In one or more variations, the transaction manager 116 performs one or more operations in conjunction with a transaction application and the payment manager 118 performs one or more operations in conjunction with a payment application linked to the transaction application in an application ecosystem.

In one or more examples, the transaction manager 116 and/or the transaction manager 124 monitors a transaction application and detects a transaction event (e.g., data associated with a transaction event) based on the monitoring. The transaction manager 116 and/or the transaction manager 124 detects that an order is made on the transaction application for a variety of products. The payment manager 118 and/or the payment manager 126 detects payment for the transaction event based on a payment application linked to the transaction application. The payment manager 118 and/or the payment manager 126 captures data associated with the transaction event (e.g., total order value, seller, date, time, number of items in the order, etc.). The payment manager 118 and/or the payment manager 126 assigns a transaction identifier (e.g., numeric code, alphabetic code, alphanumeric code, etc.) to the transaction event and stores the transaction identifier (e.g., unique transaction identifier) with the data of the transaction event.

In one or more examples, based on the payment manager 118 and/or the payment manager 126 determining that a transaction application and/or a payment application are linked in an application ecosystem, the payment manager 118 and/or the payment manager 126 requests additional information for the transaction event. In some cases, the request includes the transaction identifier. Additionally or alternatively, the transaction application determines that the payment application and the transaction application are linked in the application ecosystem and automatically sends the line-item details for the transaction event.

In one or more implementations, the transaction manager 116 and/or the transaction manager 124 detects a transaction event in a transaction application that is linked to a payment application in an application ecosystem. In some cases, the device applications 112 include the transaction application, the payment application, and/or the application ecosystem. The payment manager 118 and/or the payment manager 126 identifies a request for payment communicated from the transaction application to the payment application. In some examples, the payment manager 118 and/or the payment manager 126 requests authorization for the payment request. For example, the payment manager 118 and/or the payment manager 126 displays a prompt on a screen of the electronic device 102 that requests authorization of the payment request. In one or more examples, the prompt includes a request message (e.g., “Do you authorize payment for the transaction event on the identified transaction application?”), a first selectable control to authorize payment, and/or a second selectable control to deny payment. The payment manager 118 and/or the payment manager 126 determines the request for payment of the transaction event is authorized based on input received at the prompt (e.g., from the payment application).

In one or more implementations, the payment manager 118 and/or the payment manager 126 generates a transaction identifier (e.g., unique to the transaction event) and then records a total amount spent for the transaction event with the transaction identifier. The payment manager 118 and/or the payment manager 126 receives (e.g., from the transaction application via the communication network 106) line-item details of the transaction event. Reception of the line-item details of the transaction event is based on a request for the line-item details that is generated and sent over the communication network 106 by the payment manager 118 and/or the payment manager 126 based on the transaction application being linked to the payment application in the application ecosystem. In one or more variations, the request includes the transaction identifier of the transaction event.

In one or more implementations, the transaction controller 114 analyzes the line-item details and identifies each item purchased in the transaction event based on the analysis. Additionally or alternatively, the transaction controller 114 assigns categories to each item identified in the transaction event. The transaction controller generates a statement (e.g., spend insights statement) based on the assigned categories. In one or more variations, the transaction event appears as a single transaction with a total amount spent. The transaction controller 114 enables the single transaction to expand to view the categories assigned to each item in purchased in the transaction event along with the amount spent for each single item. For all categorization purposes, when a summary of expenses is produced, the transaction controller 114 provides categorization for each item in a given transaction event. In one or more variations, the transaction controller 114 provides the statement to one or more entities (e.g., to a user of the electronic device 102, to a payment service associated with the payment application 122, to a seller associated with the transaction application 120, etc.).

In one or more examples, reception of the line-item details of the transaction event is based on the transaction application 120 being triggered to send the line-item details of the transaction event over the communication network 106 based on the transaction application 120 being linked to the payment application 122 in the application ecosystem 104. Additionally or alternatively, reception of the line-item details of the transaction event is based on the transaction application 120 being triggered to send the line-item details of the transaction event over the communication network 106 in response to the transaction controller 114, in conjunction with the payment application 122, communicating the transaction identifier to the transaction application based on the link of the application ecosystem between the payment application 122 and the transaction application 120 and/or via the communication network 106.

In one or more implementations, the line-item details are communicated from the application ecosystem 104 (e.g., from the transaction application 120 and/or the payment application 122) to the electronic device 102. In the illustrated example, the transaction controller 114 of the electronic device 102 requests the line-item details over the communication network 106 and then receives the line-item details over the communication network 106.

In implementations a transaction event occurs via the transaction application 120 on the application ecosystem 104 and the transaction manager 116 of the electronic device 102 and/or the transaction manager 124 of the application ecosystem 104 sends a payment request to the payment application 122 and/or the electronic device 102 via the communication network 106. The payment manager 118 and/or the payment manager 126 receives the payment request and prompts the authorization on the screen of the electronic device 102. Upon receiving approval of the authorization, the payment manager 118 and/or the payment manager 126 communicates the payment approval and a transaction identifier of the transaction event to the application ecosystem 104 via the communication network 106. Thus, shopping occurs on the application ecosystem 104 and payment is authorized on the electronic device 102. Additionally or alternatively, the payment manager 118 and/or the payment manager 126 requests from the application ecosystem 104 the line-item details for the transaction event, and the transaction manager 116 and/or the transaction manager 124 of the application ecosystem 104 communicates the line-item details to the electronic device 102 directly and/or via the communication network 106.

In one or more implementations, the transaction controller 114 of the electronic device 102 sends a request to a third party 130 via the communication network 106. In one or more variations, the third party 130 includes a seller associated with the transaction event and the line-item details are stored on a database (e.g., cloud storage) of the seller, a transaction server of the seller, and/or a seller application. Additionally or alternatively, the third party 130 includes a payment entity (e.g., financial institution) associated with the transaction event and/or payment of the transaction event and the line-item details are stored on a database (e.g., cloud storage) of the payment entity. In some cases, the request includes the transaction identifier, a payment entity server, and/or a payment entity application. Accordingly, the third party 130 receives the request via the communication network 106 and then provides the requested line-item details to the electronic device 102 via the communication network 106.

The payment manager 118 and/or the payment manager 126 analyzes the line-item details in relation to multiple available categories and assigns a category to each item purchased in the transaction event based on the analysis. In one or more examples, the payment manager 118 and/or the payment manager 126 identifies an item of the transaction event as an outlier that indicates potentially fraudulent activity based on analysis of the transaction event. The analysis of the transaction event includes analysis of at least one of a category assigned to the item, a time of day for the transaction event, an amount spent for the item, a location of the mobile device at the time of the transaction event, or a location of a seller associated with the transaction event.

In one or more implementations, the payment manager 118 and/or the payment manager 126 records the line-item details and the category assigned to each item together with the transaction identifier and the total amount spent for the transaction event. Based on the line-item details and/or analysis of the line-item details, the payment manager 118 and/or the payment manager 126 generates a spending report (e.g., spend insights) that includes at least one of the transaction identifier, the total amount spent for the transaction event, the line-item details, or the category assigned to each item in the transaction event. The payment manager 118 and/or the payment manager 126 then sends the spending report to one or more preassigned recipients via the communication network 106. The one or more preassigned recipients include at least one of a user of the electronic device 102, a user of the application ecosystem 104, a user of the transaction application 120, a user of the payment application 122, an entity associated with the transaction application 120 (e.g., a seller), or an entity associated with the payment application 122 (e.g., a financial institution).

In one or more examples, the electronic device 102 interfaces with the transaction application 120 and/or the payment application 122 (e.g., via the device interface module 110). For example, the electronic device 102 receives input (e.g., via a user of the electronic device 102 or the application ecosystem 104) in relation to the transaction application 120 to initiate a transaction (e.g., a transaction event). Via the transaction controller 114 of the electronic device 102, an order for one or more items is placed on the transaction application 120.

The transaction manager 124 detects the transaction and directs a payment request for the transaction to the payment application 122. The payment application 122 receives the payment request and the payment manager 126 causes a request for authorization of the payment to be displayed on a screen of the electronic device 102. The payment manager 126 detects the payment is authorized based on input received by the electronic device 102. The payment manager 126 generates and assigns a transaction identifier to the transaction. The payment manager 126 stores the transaction identifier with the details of the transaction (e.g., total amount spent, date of transaction, seller id, etc.),

The payment manager 126 alerts the spend insight manager 128 that the transaction is from the transaction application 120 and that the transaction application 120 and the payment application 122 are linked via the application ecosystem 104. The spend insight manager 128 requests additional information (e.g., line-item details) from the transaction application 120 based on the transaction application 120 and the payment application 122 being linked via the application ecosystem 104. Additionally or alternatively, the transaction manager 124 provides the additional information based on the transaction manager 124 determining that the transaction application 120 and the payment application 122 are linked via the application ecosystem 104. Accordingly, the transaction manager 124 provides the additional information to the payment application 122.

In one or more examples, the spend insight manager 128 analyzes the additional information of the transaction and identifies each item purchased in the transaction and assigns a category for each identified item. The spend insight manager 128 generates a spend insight report that identifies each item purchased in the transaction, the amount spent for each item, and the category assigned to each item. The spend insight manager 128 provides the spend insight report to a user associated with the transaction (e.g., shopper, buyer, payer, payment authorizer). Additionally or alternatively, the spend insight manager 128 provides the spend insight report to the third party 130 associated with the transaction (e.g., seller, business, financial institution).

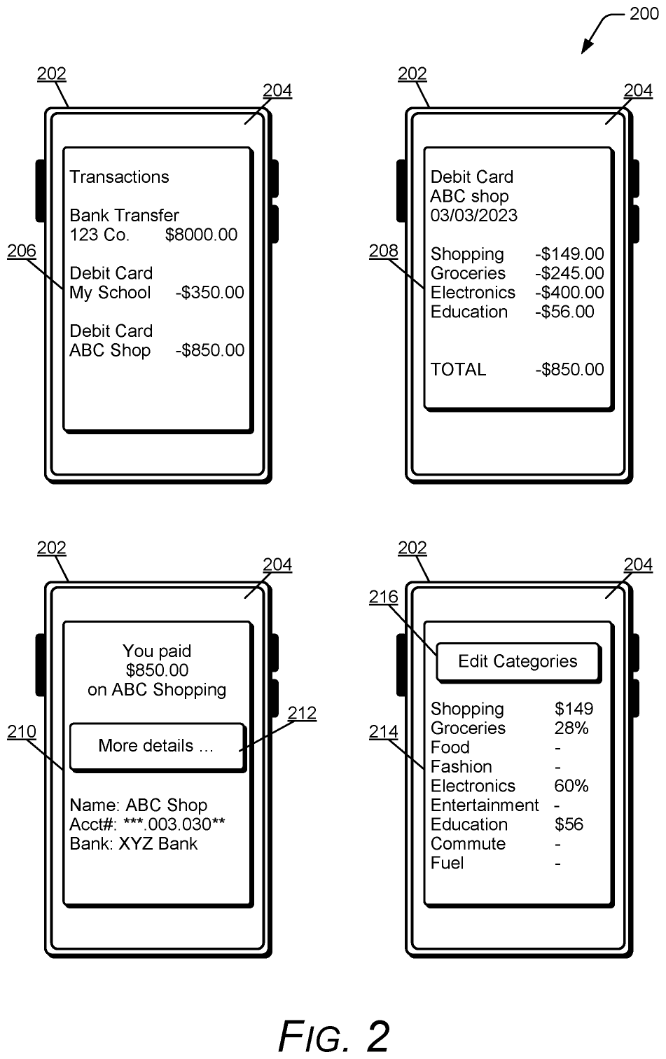

FIG. 2 illustrates example 200 of automatic multi-categorization of transactions, as described herein. As shown, the example 200 includes a mobile device 202 (e.g., the electronic device 102). In the illustrated example, the mobile device 202 includes a screen 204. In one or more examples, the screen 204 is a touchscreen configured to display content and receive input (e.g., touch input via a user interface such as a user interface of the electronic device 102).

In one or more examples, the screen 204 displays a list of transactions 206. As shown, the list of transactions include a bank transfer for $8000 from 123 Co., a debit card charge for $350 from My School, and a debit card charge for $850 from ABC Shop.

Based on the transaction categorization functionality provided by the transaction controller 114 as described herein, the screen 204 displays a spend insight report 208 of the $850 charge from ABC shop. As shown, the spend insight report 208 includes line-item details for each item in the $850 transaction event with a category assigned to each item (e.g., a shopping charge for $149, groceries charge for $245, electronics charge for $400, education charge for $56).

In the illustrated example, the screen 204 displays a summary 210 for the $850 charge from ABC shop. As shown, the summary 210 includes an active link 212 for more information on the $850 charge from ABC shop (e.g., a link to the spend insight report 208, a link to a category view 214, etc.).

In one or more examples, the screen 204 displays the category view 214. The category view 214 allows categories to be changed, added, removed, etc. via an edit categories link 216 (e.g., touch input via a user interface such as a user interface of the electronic device 102). As shown, the category view 214 shows amounts paid for each category associated with the $850 charge from ABC shop. The category view 214 enables an amount to be displayed and edited as a dollar amount (e.g., $149 of the $850 charge for shopping, $56 of the $850 charge for education) and/or a percentage of the $850 total charge (e.g., 28% of the $850 charge for groceries, 60% of the $850 charge for electronics).

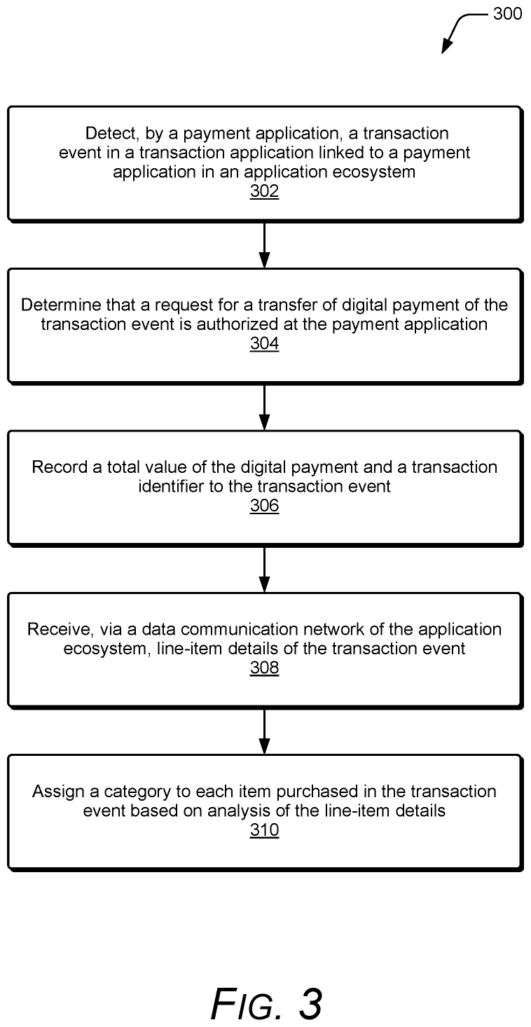

Example methods 300, 400, and 500 are described with reference to respective FIGS. 3, 4, and 5 in accordance with one or more implementations of automatic multi-categorization of transactions, as described herein. Generally, any services, components, modules, managers, controllers, methods, and/or operations described herein can be implemented using software, firmware, hardware (e.g., fixed logic circuitry), manual processing, or any combination thereof. Some operations of the example methods are described in the general context of executable instructions stored on computer-readable storage memory that is local and/or remote to a computer processing system, and one or more implementations include software applications, programs, functions, and the like. Alternatively or in addition, any of the functionality described herein is performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

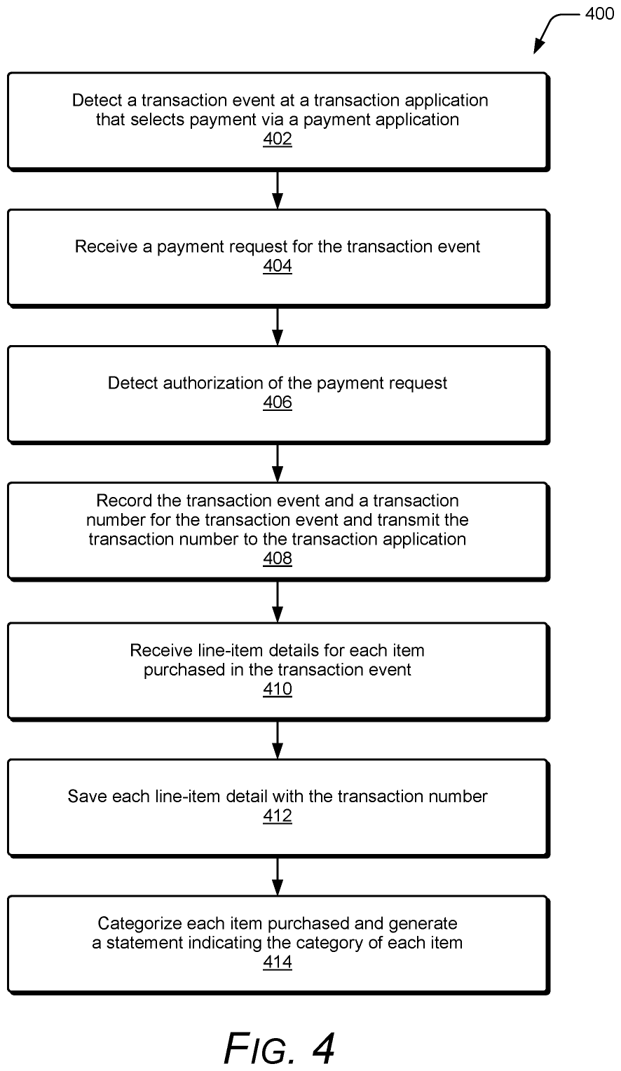

FIG. 3 illustrates example method(s) 300 for automatic multi-categorization of transactions. The order in which the method is described is not intended to be construed as a limitation, and any number or combination of the method operations described herein (e.g., of FIGS. 3, 4, and/or 5) may be performed in any order to perform a method, or an alternate method.

At 302, the method 300 includes detecting, by a payment application, a transaction event in a transaction application linked to the payment application in an application ecosystem. For example, the transaction controller 114 detects a transaction event associated with the transaction application 120 that is linked to the payment application 122 in the application ecosystem 104.

At 304, the method 300 includes determining that a request for a transfer of digital payment of the transaction event is authorized at the payment application. For example, the transaction controller 114 determines the transaction application 120 determines that a requests for payment of the transaction event is authorized by the payment application 122.

At 306, the method 300 includes recording a total value of the digital payment and a transaction identifier to the transaction event. For example, the transaction controller 114 (e.g., in conjunction with the payment application 122) generates a transaction identifier to the transaction event and then records a total amount spent for the transaction event together with the transaction identifier.

At 308, the method 300 includes receiving, via a data communication network of the application ecosystem, line-item details of the transaction event. For example, the transaction application 120 sends the line-item details of the transaction event to the payment application 122. In one or more variations, the transaction application 120 sends the line-item details of the transaction event to the payment application 122 via the communication network 106.

At 310, the method 300 includes assigning a category to each item purchased in the transaction event based on analysis of the line-item details. For example, the transaction controller 114 assigns a category to each item purchased in the transaction event based on analysis the transaction controller 114 performs on the line-item details.

FIG. 4 illustrates example method(s) 400 for automatic multi-categorization of transactions. The order in which the method is described is not intended to be construed as a limitation, and any number or combination of the method operations described herein (e.g., of FIGS. 3, 4, and/or 5) may be performed in any order to perform a method, or an alternate method.

At 402, the method 400 includes detecting a transaction event at a transaction application that selects payment via a payment application. In example implementations, the transaction controller 114 detects that a transaction event at the transaction application 120 selects payment via the payment application 122 (e.g., requests payment via the payment application 122).

At 404, the method 400 includes receiving a payment request for the transaction event. In example implementations, the transaction controller 114 receives from the transaction application 120 a payment request for the transaction event.

At 406, the method 400 includes detecting authorization of the payment request. In example implementations, the transaction controller 114 detects authorization of the payment request. For example, the transaction controller 114 detects a user input (e.g., via a user interface of the electronic device 102) authorizing the payment request. Additionally or alternatively, the transaction controller 114 automatically authorizes the payment request when an amount of the transaction event is below a preset amount threshold (e.g., total amount is below $50). The transaction controller 114 sends the authorization to the transaction application 120.

At 408, the method 400 includes recording the transaction event and a transaction number for the transaction event and transmitting the transaction number to the transaction application. In example implementations, the transaction controller 114 generates a transaction number based on detecting that the transaction event at the transaction application 120 selects payment via the payment application 122 (e.g., based on the transaction application 120 and the payment application 122 being linked in the application ecosystem 104). The transaction controller 114 records the transaction event and the transaction number and transmits the transaction number to the transaction application 120.

At 410, the method 400 includes receiving line-item details for each item purchased in the transaction event. In example implementations, the transaction controller 114 receives the line-item details (e.g., line-item details), which provides information for each item purchased in the transaction event.

At 412, the method 400 includes saving each line-item detail with the transaction number. In example implementations, the transaction controller 114 stores the line-item details together with the transaction number (e.g., in a storage device of the electronic device 102 and/or in a storage device of the application ecosystem 104).

At 414, the method 400 includes categorizing each item purchased and generating a statement indicating the category of each item. In example implementations, the transaction controller 114 analyzes the line-item details and then categorizes each item purchased based on the analysis. In one or more examples, the transaction controller 114 generates a statement (e.g., spend insight statement) that indicates the category of each item.

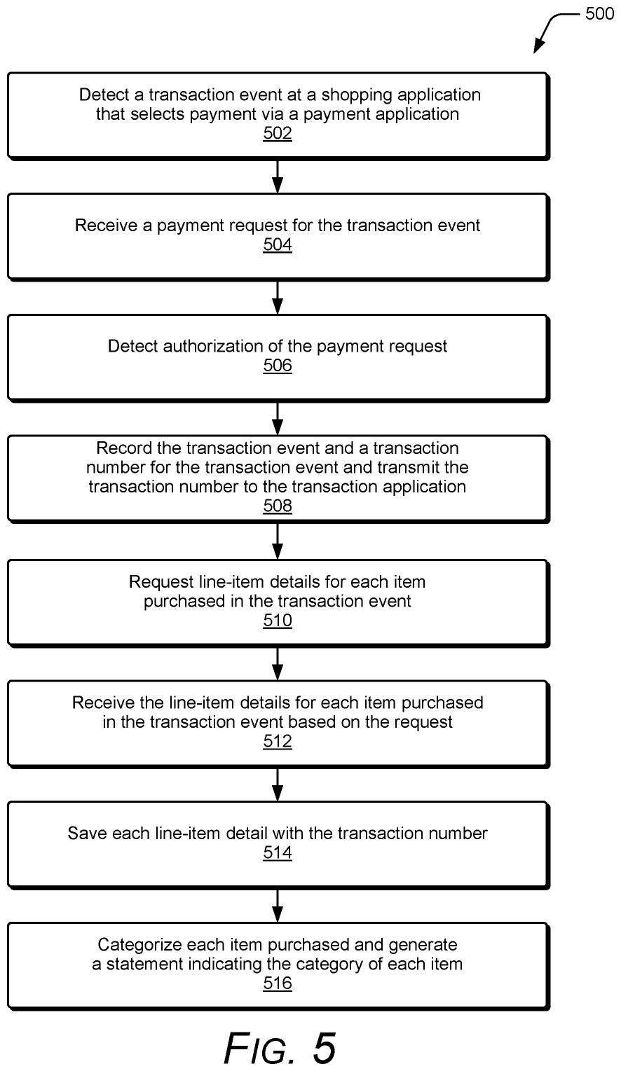

FIG. 5 illustrates example method(s) 500 for automatic multi-categorization of transactions. The order in which the method is described is not intended to be construed as a limitation, and any number or combination of the method operations described herein (e.g., of FIGS. 3, 4, and/or 5) may be performed in any order to perform a method, or an alternate method.

At 502, the method 500 includes detecting a transaction event at a transaction application that selects payment via a payment application. In example implementations, the transaction controller 114 detects that a transaction event at the transaction application 120 selects payment via the payment application 122. For example, the transaction controller 114 detects that the transaction application 120 requests payment for the transaction event via the payment application 122.

At 504, the method 500 includes receiving a payment request for the transaction event. In example implementations, the transaction controller 114 receives (e.g., via the communication network 106) a payment request for the transaction event from the transaction application 120.

At 506, the method 500 includes detecting authorization of the payment request. In example implementations, the transaction controller 114 detects authorization of the payment request. For example, the transaction controller 114 detects a user input (e.g., via a user interface of the electronic device 102) authorizing the payment request. In one or more variations, the transaction controller 114 automatically authorizes the payment request when an amount of the transaction event is below a preset amount threshold (e.g., total amount is below $50). The transaction controller 114 sends the authorization to the transaction application 120 via the communication network 106.

At 508, the method 500 includes recording the transaction event and a transaction number for the transaction event and transmitting the transaction number to the transaction application. In example implementations, the transaction controller 114 generates a transaction number based on detecting that the transaction event at the transaction application 120 selects payment via the payment application 122 and/or that the transaction application 120 and the payment application 122 are linked in the application ecosystem 104. The transaction controller 114 records the transaction event and the transaction number and transmits the transaction number to the transaction application 120.

At 510, the method 500 includes requesting line-item details for each item purchased in the transaction event. In example implementations, the transaction controller 114 transmits a request (e.g., via the communication network 106) for line-item details of the transaction event. For example, the transaction controller 114 sends a line-item request to the transaction application 120 via the communication network 106.

At 512, the method 500 includes receiving line-item details for each item purchased in the transaction event. Based on the request sent at 510, the transaction controller 114 receives the line-item details from the transaction application 120 (e.g., via the communication network 106).

At 514, the method 500 includes saving each line-item detail with the transaction number. In example implementations, the transaction controller 114 stores the line-item details together with the transaction number (e.g., in a storage device of the electronic device 102, in a storage device of the application ecosystem 104, and/or in cloud storage).

At 516, the method 500 includes categorizing each item purchased and generating a statement indicating the category of each item. In example implementations, the transaction controller 114 analyzes the line-item details and then categorizes each item purchased based on the analysis. In one or more examples, the transaction controller 114 generates a statement (e.g., spend insight statement) that indicates the category of each item.

FIG. 6 illustrates various components of an example device 600, which can implement aspects of the techniques and features for automatic multi-categorization of transactions, as described herein. The example device 600 may be implemented as any of the devices described with reference to the previous FIGS. 1-6, such as any type of a wireless device, mobile device, mobile phone, flip phone, client device, companion device, paired device, display device, tablet, computing, communication, entertainment, gaming, media playback, and/or any other type of computing and/or electronic device. For example, the electronic device 102 and/or the application ecosystem 104 described with reference to FIGS. 1-6 may be implemented as the example device 600.

The example device 600 can include various, different communication devices 602 that enable wired and/or wireless communication of device data 604 with other devices. The device data 604 can include any of the various devices data and content that is generated, processed, determined, received, stored, and/or communicated from one computing device to another. Generally, the device data 604 can include any form of audio, video, image, graphics, and/or electronic data that is generated by applications executing on a device. The communication devices 602 can also include transceivers for cellular phone communication and/or for any type of network data communication.

The example device 600 can also include various, different types of data input/output (I/O) interfaces 606, such as data network interfaces that provide connection and/or communication links between the devices, data networks, and other devices. The I/O interfaces 606 may be used to couple the device to any type of components, peripherals, and/or accessory devices, such as a computer input device that may be integrated with the example device 600. The I/O interfaces 606 may also include data input ports via which any type of data, information, media content, communications, messages, and/or inputs may be received, such as user inputs to the device, as well as any type of audio, video, image, graphics, and/or electronic data received from any content and/or data source.

The example device 600 includes a processor system 608 of one or more processors (e.g., any of microprocessors, controllers, and the like) and/or a processor and memory system implemented as a system-on-chip (SoC) that processes computer-executable instructions. The processor system 608 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 610. The example device 600 may also include any type of a system bus or other data and command transfer system that couples the various components within the device. A system bus can include any one or combination of different bus structures and architectures, as well as control and data lines.

The example device 600 also includes memory and/or memory devices 612 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 612 include volatile memory and non-volatile memory, fixed and removable mobile devices, and any suitable memory device or electronic data storage that maintains data for computing device access. The memory devices 612 can include various implementations of random-access memory (RAM), read-only memory (ROM), flash memory, and other types of storage media in various memory device configurations. The example device 600 may also include a mass storage mobile device.

The memory devices 612 (e.g., as computer-readable storage memory) provide data storage mechanisms, such as to store the device data 604, other types of information and/or electronic data, and various device applications 614 (e.g., software applications and/or modules). For example, an operating system 616 may be maintained as software instructions with a memory device 612 and executed by the processor system 608 as a software application. The device applications 614 may also include a device manager, such as any form of a control application, software application, signal-processing and control module, code that is specific to a particular device, a hardware abstraction layer for a particular device, and so on.

In one or more examples, the device 600 includes a transaction controller 618 that implements various aspects of the described features and techniques described herein. The transaction controller 618 is implemented with hardware components and/or in software as one of the device applications 614, such as when the example device 600 is implemented as the electronic device 102 and/or the application ecosystem 104 described with reference to FIGS. 1-6. An example of the transaction controller 618 is the transaction controller 114 implemented by the electronic device 102 and/or the application ecosystem 104, such as a software application and/or as hardware components in the electronic device 102 and/or in the application ecosystem 104. In implementations, the transaction controller 618 includes independent processing, memory, and logic components as a computing and/or electronic device integrated with the example device 600.

The example device 600 can also include a microphone 620 (e.g., to capture an audio recording of a user) and/or camera devices 622 (e.g., to capture video images of the user during a call), as well as motion sensors 624, such as may be implemented as components of an inertial measurement unit (IMU). The motion sensors 624 may be implemented with various sensors, such as a gyroscope, an accelerometer, and/or other types of motion sensors to sense motion of the device. The motion sensors 624 can generate sensor data vectors having three-dimensional parameters (e.g., rotational vectors in x, y, and z-axis coordinates) indicating location, position, acceleration, rotational speed, and/or orientation of the device. The example device 600 can also include one or more power sources 626, such as when the device is implemented as a wireless device and/or mobile device. The power sources may include a charging and/or power system, and may be implemented as a flexible strip battery, a rechargeable battery, a charged super-capacitor, and/or any other type of active or passive power source.

The example device 600 can also include an audio and/or video processing system 628 that generates audio data for an audio system 630 and/or generates display data for a display system 632. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 600. Alternatively, the audio system and/or the display system are external, peripheral components to the example device.

Although implementations for automatic multi-categorization of transactions have been described in language specific to features and/or methods, the appended claims are not necessarily limited to the specific features or methods described. Rather, the specific features and methods are disclosed as example implementations for automatic multi-categorization of transactions, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to an electronic device including: at least one memory; and at least one processor coupled to the at least one memory and configured to cause the electronic device to: detect a transaction event in a transaction application linked to a payment application in an application ecosystem; determine that a request for a transfer of digital payment of the transaction event is authorized at the payment application; record a total value of the digital payment and a transaction identifier for the transaction event; receive, from the transaction application via a data communication network of the application ecosystem, line-item details of the transaction event; and assign, from a plurality of categories, a category to each item purchased in the transaction event based on analysis of the line-item details.

In some aspects, the techniques described herein relate to an electronic device, wherein the at least one processor is configured to cause the electronic device to identify an item of the transaction event as an outlier that indicates potential fraudulent activity based on at least one of the category assigned to the item, a time of day for the transaction event, an amount spent for the item, a location of the electronic device at the time of the transaction event, a location of a seller associated with the transaction event.

In some aspects, the techniques described herein relate to an electronic device, wherein reception of the line-item details of the transaction event is based on a request for the line-item details that is generated and sent over the data communication network based on the transaction application being linked to the payment application in the application ecosystem.

In some aspects, the techniques described herein relate to an electronic device, wherein the request includes the transaction identifier of the transaction event.

In some aspects, the techniques described herein relate to an electronic device, wherein reception of the line-item details of the transaction event is based on the transaction application being triggered to send the line-item details of the transaction event over the data communication network based on the transaction application being linked to the payment application in the application ecosystem.

In some aspects, the techniques described herein relate to an electronic device, wherein reception of the line-item details of the transaction event is based on the transaction application being triggered to send the line-item details of the transaction event over the data communication network in response to communication of the transaction identifier from the payment application via the data communication network of the application ecosystem.

In some aspects, the techniques described herein relate to an electronic device, wherein the at least one processor is configured to cause the electronic device to record the line-item details and the category assigned to each item with the transaction identifier and the total value spent for the transaction event.

In some aspects, the techniques described herein relate to an electronic device, wherein the at least one processor is configured to cause the electronic device to: generate a spending report that includes the transaction identifier, a total value spent, the line-item details, and the category assigned to each item in the transaction event; and send over the data communication network the spending report to one or more preassigned recipients.

In some aspects, the techniques described herein relate to an electronic device, wherein the one or more preassigned recipients include at least one of a user of the transaction application, a user of the payment application, an entity associated with the transaction application, or an entity associated with the payment application.

In some aspects, the techniques described herein relate to a method including: detecting a transaction event in a transaction application linked to a payment application in an application ecosystem; determining that a request for a transfer of digital payment of the transaction event is authorized at the payment application; recording a total value of the digital payment and a transaction identifier for the transaction event; receiving, from the transaction application via a data communication network of the application ecosystem, line-item details of the transaction event; and assigning, from a plurality of categories, a category to each item purchased in the transaction event based on analysis of the line-item details.

In some aspects, the techniques described herein relate to a method, further including identifying an item of the transaction event as an outlier that indicates potential fraudulent activity based on at least one of the category assigned to the item, a time of day for the transaction event, an amount spent for the item, a location of an electronic device at the time of the transaction event, a location of a seller associated with the transaction event.

In some aspects, the techniques described herein relate to a method, wherein reception of the line-item details of the transaction event is based on a request for the line-item details that is generated and sent over the data communication network based on the transaction application being linked to the payment application in the application ecosystem, and wherein the request includes the transaction identifier of the transaction event.

In some aspects, the techniques described herein relate to a method, wherein reception of the line-item details of the transaction event is based on the transaction application being triggered to send the line-item details of the transaction event over the data communication network based on the transaction application being linked to the payment application in the application ecosystem.

In some aspects, the techniques described herein relate to a method, wherein reception of the line-item details of the transaction event is based on the transaction application being triggered to send the line-item details of the transaction event over the data communication network in response to the transaction application receiving the transaction identifier from the payment application via the data communication network of the application ecosystem.

In some aspects, the techniques described herein relate to a method, further including recording the line-item details and the category assigned to each item with the transaction identifier and the total value of the digital payment.

In some aspects, the techniques described herein relate to a method, further including: generating a spending report that includes the transaction identifier, the total value of the digital payment, the line-item details, and the category assigned to each item in the transaction event; and sending over the data communication network the spending report to one or more preassigned recipients.

In some aspects, the techniques described herein relate to a system including: a data communication network; and a transaction controller configured to control aspects of automatic categorization of purchase transactions, the transaction controller implemented at least partially in computer hardware to: detect a transaction event in a transaction application linked to a payment application in an application ecosystem; determine that a request for a transfer of digital payment of the transaction event is authorized at the payment application; record a total value of the digital payment and a transaction identifier for the transaction event; receive, from the transaction application via the data communication network of the application ecosystem, line-item details of the transaction event; and assign, from a plurality of categories, a category to each item purchased in the transaction event based on analysis of the line-item details.

In some aspects, the techniques described herein relate to a system, wherein the transaction controller is configured to identify an item of the transaction event as an outlier that indicates potential fraudulent activity based on at least one of the category assigned to the item, a time of day for the transaction event, an amount spent for the item, a location of an electronic device at the time of the transaction event, a location of a seller associated with the transaction event.

In some aspects, the techniques described herein relate to a system, wherein reception of the line-item details of the transaction event is based on a request for the line-item details that is generated and sent over the data communication network based on the transaction application being linked to the payment application in the application ecosystem, and wherein the request includes the transaction identifier of the transaction event.

In some aspects, the techniques described herein relate to a system, wherein reception of the line-item details of the transaction event is based on the transaction application being triggered to send the line-item details of the transaction event over the data communication network based on the transaction application being linked to the payment application in the application ecosystem.

1. An electronic device comprising:
at least one memory; and
at least one processor coupled to the at least one memory and configured to cause the electronic device to:
detect a transaction event in a transaction application linked to a payment application in an application ecosystem;
determine that a request for a transfer of digital payment of the transaction event is authorized at the payment application;
record a total value of the digital payment and a transaction identifier for the transaction event;
receive, from the transaction application via a data communication network of the application ecosystem, line-item details of the transaction event; and
assign, from a plurality of categories, a category to each item purchased in the transaction event based on analysis of the line-item details.

2. The electronic device of claim 1, wherein the at least one processor is configured to cause the electronic device to identify an item of the transaction event as an outlier that indicates potential fraudulent activity based on at least one of the category assigned to the item, a time of day for the transaction event, an amount spent for the item, a location of the electronic device at the time of the transaction event, a location of a seller associated with the transaction event.

3. The electronic device of claim 1, wherein reception of the line-item details of the transaction event is based on a request for the line-item details that is generated and sent over the data communication network based on the transaction application being linked to the payment application in the application ecosystem.

4. The electronic device of claim 3, wherein the request includes the transaction identifier of the transaction event.

5. The electronic device of claim 1, wherein reception of the line-item details of the transaction event is based on the transaction application being triggered to send the line-item details of the transaction event over the data communication network based on the transaction application being linked to the payment application in the application ecosystem.

6. The electronic device of claim 1, wherein reception of the line-item details of the transaction event is based on the transaction application being triggered to send the line-item details of the transaction event over the data communication network in response to communication of the transaction identifier from the payment application via the data communication network of the application ecosystem.

7. The electronic device of claim 1, wherein the at least one processor is configured to cause the electronic device to record the line-item details and the category assigned to each item with the transaction identifier and the total value spent for the transaction event.

8. The electronic device of claim 1, wherein the at least one processor is configured to cause the electronic device to:
generate a spending report that includes the transaction identifier, a total value spent, the line-item details, and the category assigned to each item in the transaction event; and
send over the data communication network the spending report to one or more preassigned recipients.

9. The electronic device of claim 8, wherein the one or more preassigned recipients include at least one of a user of the transaction application, a user of the payment application, an entity associated with the transaction application, or an entity associated with the payment application.

10. A method comprising:
detecting a transaction event in a transaction application linked to a payment application in an application ecosystem;
determining that a request for a transfer of digital payment of the transaction event is authorized at the payment application;
recording a total value of the digital payment and a transaction identifier for the transaction event;
receiving, from the transaction application via a data communication network of the application ecosystem, line-item details of the transaction event; and
assigning, from a plurality of categories, a category to each item purchased in the transaction event based on analysis of the line-item details.

11. The method of claim 10, further comprising identifying an item of the transaction event as an outlier that indicates potential fraudulent activity based on at least one of the category assigned to the item, a time of day for the transaction event, an amount spent for the item, a location of an electronic device at the time of the transaction event, a location of a seller associated with the transaction event.

12. The method of claim 10, wherein reception of the line-item details of the transaction event is based on a request for the line-item details that is generated and sent over the data communication network based on the transaction application being linked to the payment application in the application ecosystem, and wherein the request includes the transaction identifier of the transaction event.

13. The method of claim 10, wherein reception of the line-item details of the transaction event is based on the transaction application being triggered to send the line-item details of the transaction event over the data communication network based on the transaction application being linked to the payment application in the application ecosystem.

14. The method of claim 10, wherein reception of the line-item details of the transaction event is based on the transaction application being triggered to send the line-item details of the transaction event over the data communication network in response to the transaction application receiving the transaction identifier from the payment application via the data communication network of the application ecosystem.

15. The method of claim 10, further comprising recording the line-item details and the category assigned to each item with the transaction identifier and the total value of the digital payment.

16. The method of claim 10, further comprising:
generating a spending report that includes the transaction identifier, the total value of the digital payment, the line-item details, and the category assigned to each item in the transaction event; and
sending over the data communication network the spending report to one or more preassigned recipients.

17. A system comprising:
a data communication network; and
a transaction controller configured to control aspects of automatic categorization of purchase transactions, the transaction controller implemented at least partially in computer hardware to:
detect a transaction event in a transaction application linked to a payment application in an application ecosystem;
determine that a request for a transfer of digital payment of the transaction event is authorized at the payment application;
record a total value of the digital payment and a transaction identifier for the transaction event;
receive, from the transaction application via the data communication network of the application ecosystem, line-item details of the transaction event; and
assign, from a plurality of categories, a category to each item purchased in the transaction event based on analysis of the line-item details.

18. The system of claim 17, wherein the transaction controller is configured to identify an item of the transaction event as an outlier that indicates potential fraudulent activity based on at least one of the category assigned to the item, a time of day for the transaction event, an amount spent for the item, a location of an electronic device at the time of the transaction event, a location of a seller associated with the transaction event.

19. The system of claim 17, wherein reception of the line-item details of the transaction event is based on a request for the line-item details that is generated and sent over the data communication network based on the transaction application being linked to the payment application in the application ecosystem, and wherein the request includes the transaction identifier of the transaction event.

20. The system of claim 17, wherein reception of the line-item details of the transaction event is based on the transaction application being triggered to send the line-item details of the transaction event over the data communication network based on the transaction application being linked to the payment application in the application ecosystem.
